(19) United States
(12) Patent Application Publication
(10) Pub. No.: US 2023/0235874 A1
(43) Pub. Date: Jul. 27, 2023

(54) Tool-less interchangeable electrical fixtures

(71) Applicants: David Frangiosa, Maywood, NJ (US); Jeffrey Frangiosa, Fair Lawn, NJ (US)

(72) Inventors: David Frangiosa, Maywood, NJ (US); Jeffrey Frangiosa, Fair Lawn, NJ (US)

(21) Appl. No.: 18/064,271

(22) Filed: Dec. 11, 2022

Related U.S. Application Data
(60) Provisional application No. 63/267,028, filed on Jan. 21, 2022.

(51) Int. Cl. F21V 17/00; F21V 17/10; H01F 7/02

(52) U.S. Cl. CPC F21V 17/002; F21V 17/105; H01F 7/02

(57) ABSTRACT

An electrical fixture comprising a housing with tool-less attachment to an electrical baseplate that enhances the ease of replacement and interchangeability of indoor and outdoor electrical fixtures. The housing defines a cavity in which quick connect electrical wiring can be attached. The housing further includes magnetic bars for connection to magnetic elements of a corresponding electrical baseplate. The electrical baseplate includes permanent magnets aligned with the magnetic bars of the housing. Said magnets are secured in compartments of the baseplate sized to receive and retain the magnetic bars of the housing. The housing will remain adhered to the baseplate through the interaction of the magnets and supporting baseplate compartments once the housing is rotated into place.

### CROSS-REFERENCE TO RELATED APPLICATIONS

This application claims the benefit of priority, under 35 U.S.C. .sctn. 119(e), of U.S. Provisional Patent Application No. 63/267,028, filed Jan. 21, 2022, the entire disclosure of which is hereby incorporated herein by reference

### FIELD OF THE INVENTION

The present invention generally relates to electrical fixtures, and more particularly to decorative indoor and outdoor lighting for purposes of tool-less replacement and interchangeability.

### BACKGROUND

Various lighting fixtures are well known in use of home décor and other applications. The installation and replacement of these fixtures has required the hardwiring of components, necessitating a functional knowledge of electrical wiring or the hiring of an electrician to replace existing fixtures. Accordingly, homeowners looking to redecorate or replace said fixtures incur the additional cost of hiring an electrician or run the risk of injury without proper knowledge of electrical wiring and safety protocols.

What is needed is an electrical fixture providing for safe and tool-less replacement without the need for knowledge of electrical wiring, to provide the flexibility for lighting and other needs in a tool-less fashion after initial installation.

### SUMMARY

The present invention provides an electrical fixture having a tool-less assembly feature. The fixture provides for tool-less replacement of existing fixtures, allowing for easy disassembly and reassembly, which eliminates the need for knowledge of electrical wiring. An exemplary fixture includes a housing that defines an internal wiring cavity. The housing further includes magnetic bars dimensioned and positioned to be received and retained by the baseplate. The baseplate includes permanent magnets positioned in compartments dimensioned and positioned to receive and retain the magnetic bars of said housing. The baseplate further includes a safety stop that prevents unwanted rotation and disengagement of the housing.

### BRIEF DESCRIPTION OF THE DRAWINGS

An understanding of the following description will be facilitated by reference to the attached drawings, in which:

FIG. 1A is a perspective view of the exterior of the electrical fixture housing, showing the surface of the housing where an electrical fixture would attach, and the wire pass through;

FIG. 1B is a bottom perspective view of the internal portion of the housing, showing the magnetic bars that are received by the baseplate, and the wire pass through;

FIG. 2 is a perspective view of the baseplate showing the compartments that house permanent magnets used to receive the magnetic bars of the housing, safety stop, universal mounting pilot holes, and the wire pass through;

FIG. 3 is a side view of a quick connect adapter;

FIG. 4 is a perspective view of the exemplary embodiment of the present invention, shown in the fully-assembled state.

### DETAILED DESCRIPTION

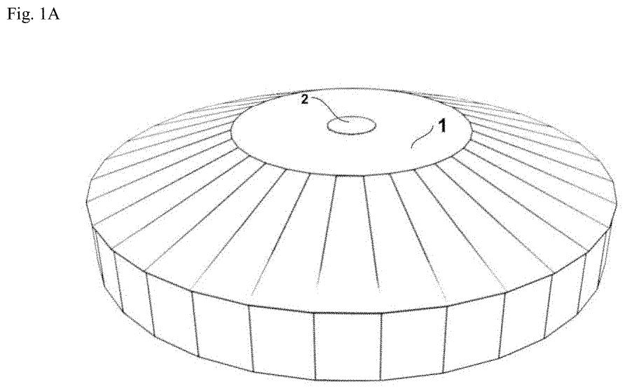

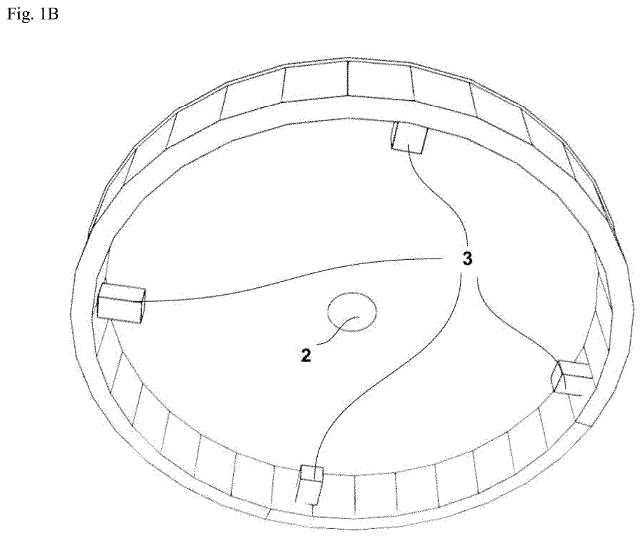

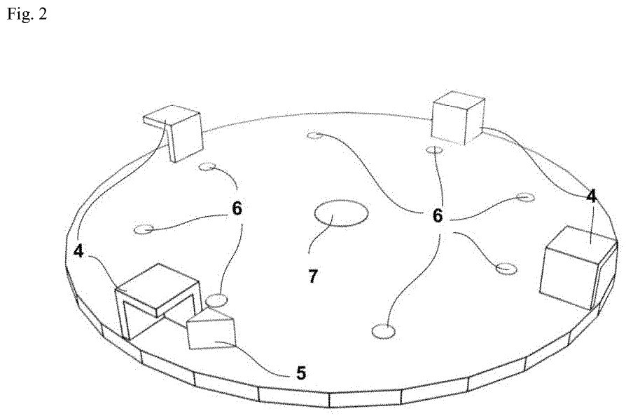

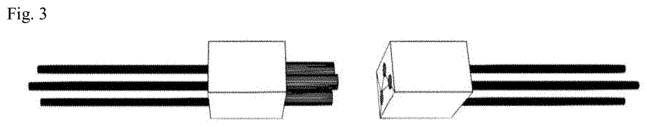

FIGS. 1-4 shows an electrical fixture in accordance with the exemplary embodiment of the present invention. In this exemplary embodiment, the housing, as best shown by FIG. 1A-B, has a cylindrical shape which defines an internal compartment, and includes a raised, flat surface (1) where the electrical devices will be permanently secured during production. The electrical devices secured to the housing may have any desired shape and style. The housing further includes a wiring channel (2) for the passage of electrical wiring into the internal compartment of the housing, which will house electrical wiring and the quick connect adapter as best shown in FIG. 3. The housing further includes four magnetic bars (3) that cooperate with permanent magnets housed in compartments (4) of the baseplate to create a magnetic attraction. As best shown by FIG. 2, the baseplate includes compartments for permanent magnets (4), a physical stop (5) to prevent unwanted rotation and disengagement of the housing, universal mounting pilot holes (6), and a wiring channel (7) for passage of the quick connect adapter FIG. 3 wires to be hardwired to a power source.

Generally, the electrical fixture comprises a sconce, dome light, pendant light, receptacle, or any other hardwired electrical device to be wall or ceiling mounted. Generally, the operative components of the fixture include an electrical housing FIG. 1A-B, electrical baseplate FIG. 2, and quick connect electrical adapter FIG. 3 operative to secure electrical devices and provide power. In accordance with the present invention, the electrical fixture has a tool-less assembly feature that facilitates easy replacement and interchangeability of existing fixtures that requires no working knowledge of electrical wiring.

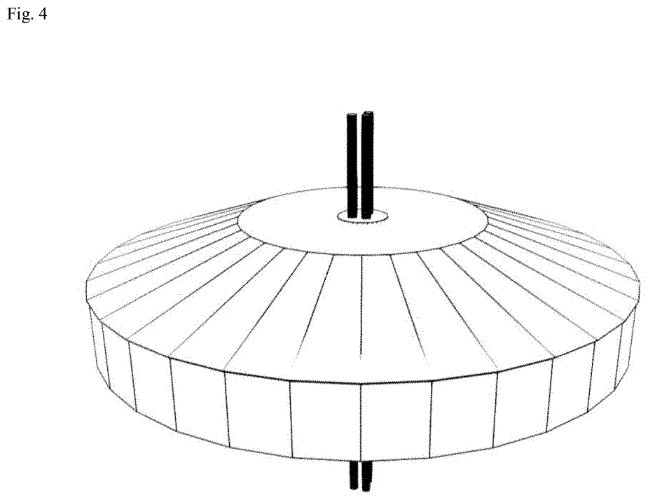

The tool-less assembly feature is implemented by one or more structures of the housing FIG. 1A-B, the baseplate FIG. 2, and the quick connect adapter FIG. 3 that provide for a supply of electrical power and assembly of components free of mechanical and non-mechanical fasteners. For example, the exemplar embodiment of the fully-assembled fixture FIG. 4, includes the four magnetic bars (3) of the housing, when rotated into place, fully received and retained by permanent magnet compartments (4) of the baseplate, creating a permanent magnetic attraction. The wiring of the quick connect adapter FIG. 3, protruding through the wiring channel in the housing (2) and the wiring channel in baseplate (7). Notably, electrical power to the housing can be safely disrupted by disconnecting the quick connect adapter FIG. 3 and the fixture allows for tool-less disassembly and reassembly facilitating easy replacement of electrical devices.

Current electrical fixtures are hardwired, and their replacement requires skills and knowledge of electrical wiring that most homeowners do not possess. A typical electrical fixture requires the power to be turned off, wires to be disconnected from the power supply, and the wires of the new fixture respliced to the power supply.

Accordingly, the present invention allows for easy tool-less replacement of existing fixtures without the need for knowledge of electrical wiring or the skills to safely hardwire devices. Further, embodiments of present invention provide tool-less assembly of the electrical housing and electrical baseplate without the use of mechanical or non-mechanical fasteners, permitting homeowners with little or no experience to safely replace electrical fixtures.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. An electrical fixture housing comprising: a cavity defined by the body of the housing and magnetic bars positioned to be received and retained by permanent magnets in compartments on a baseplate, with said baseplate comprising permanent magnets contained in compartments dimensioned and positioned to be receive and retain the magnetic bars of said electrical housing, creating a permanent electrical fixture when all aspects are engaged.

2. An electrical baseplate comprising: permanent magnets positioned within compartments sized to receive and retain magnetic bars of the housing and form a magnetic attraction, with said baseplate further comprising a physical barrier to prevent unwanted rotation and disengagement of said housing.

3. The electrical fixture housing of claim 1, wherein said magnetic bars engage with said permanent magnets in the compartments of said electrical baseplate cooperate to create a tool-less detachable interface.

4. The electrical fixture housing of claim 1, wherein said magnetic bars abut with said permanent magnet of said electrical baseplate and creates a permanent magnetic attraction.
